(19) United States
(12) Patent Application Publication
(10) Pub. No.: US 2013/0283050 A1
(43) Pub. Date: Oct. 24, 2013

(54) WIRELESS CLIENT AUTHENTICATION AND ASSIGNMENT

(71) Applicants: Anil Gupta, Shrewsbury, MA (US); Sung-Ju Lee, Redwood City, CA (US)

(72) Inventors: Anil Gupta, Shrewsbury, MA (US); Sung-Ju Lee, Redwood City, CA (US)

(21) Appl. No.: 13/453,688

(22) Filed: Apr. 23, 2012

(51) Int. Cl. G06F 21/20; H04L 9/32; H04L 9/28; H04W 12/06

(52) U.S. Cl. 713/168; 726/3; 726/7

(57) ABSTRACT

Methods, devices, and machine readable media are provided for wireless client authentication and assignment. Some examples can include a network device with a processing resource and a memory resource storing instructions executable by the processing resource to act as a default gateway and present a web portal for logon in response to a request from a wireless client prior to authentication of the wireless client, to send a dissociation command for the wireless client in response to an initial authentication of the wireless client, and to assign traffic to a local virtual local area network (VLAN) defined on an access point (AP) associated with the wireless client in response to a subsequent authentication of the wireless client. Some examples can include assigning the wireless client to an isolation VLAN that is tunneled via the network device prior to dissociation, where the local VLAN is not tunneled via the network device.

### BACKGROUND

Individual users of wireless networks may use different types of wireless devices (wireless clients) and an administrator may wish to provide different levels of access to different individual users, to different types of wireless devices, and/or to different combinations of individual users and wireless devices. For example, workers may carry a business laptop and a personal cellular telephone and wish to connect to a business wireless network with both devices. The business may wish to provide different levels of access while still maintaining security to protect the wireless network. Some previous approaches have included centralized web authentication of wireless devices.

### BRIEF DESCRIPTION OF THE DRAWINGS

FIG. 1 illustrates an example of a network according to the present disclosure.

FIG. 2 is a block diagram illustrating a processing resource, a memory resource, and a machine readable medium according to the present disclosure.

FIG. 3 is a flow chart illustrating an example of a method for wireless client authentication and assignment according to the present disclosure.

FIG. 4 is a flow chart illustrating an example of a method for wireless client authentication and assignment according to the present disclosure.

### DETAILED DESCRIPTION

Wireless networks can be provided in locations such as workplaces, schools, hotels, etc. Individual users of the wireless network may access the wireless network with different types of wireless devices (wireless clients). In some instances, a particular wireless client (e.g., a business laptop used by an employee in the workplace) may be closely affiliated with the wireless network such that it should have access to large portions of the network (e.g., the Internet and an intranet). In some instances, a particular wireless client (e.g., a personal cellular telephone used by the employee in the workplace) may be loosely affiliated with the wireless network such that it should have access to certain portions of the network (e.g., the Internet). In some instances, a particular wireless client (e.g., a tablet used by a guest in the workplace) may not be affiliated with the wireless network such that it should not have access to the network.

In some previous approaches to providing wireless networks, access for wireless clients (regardless of their level of affiliation with the network) may be provided via a centralized web authentication. The centralized web authentication may involve a wireless client attempting to connect to the network and being met with a webpage, presented by a centralized network device, requesting a username and password. The centralized network device acts as a domain name system (DNS) server and default gateway to enforce security via the webpage logon. Then, the centralized network device becomes an extra hop for traffic from the wireless client through the network, effectively creating a bottleneck for traffic from multiple clients who may be using the network. The centralized network device may also present a single point of failure for the wireless network.

In contrast, some examples of the present disclosure may include methods, devices, and machine readable media for wireless client authentication and assignment. Some examples can include a network device with a processing resource and a memory resource storing instructions executable by the processing resource to act as a default gateway and present a web portal for logon in response to a request from a wireless client prior to authentication of the wireless client, to send a dissociation command for the wireless client in response to an initial authentication of the wireless client, and to assign traffic to a local virtual local area network (VLAN) defined on an access point (AP) associated with the wireless client in response to a subsequent authentication of the wireless client. Some examples can include assigning the wireless client to an isolation VLAN that is tunneled via the network device prior to dissociation. In contrast, the local VLAN is not tunneled via the network device.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

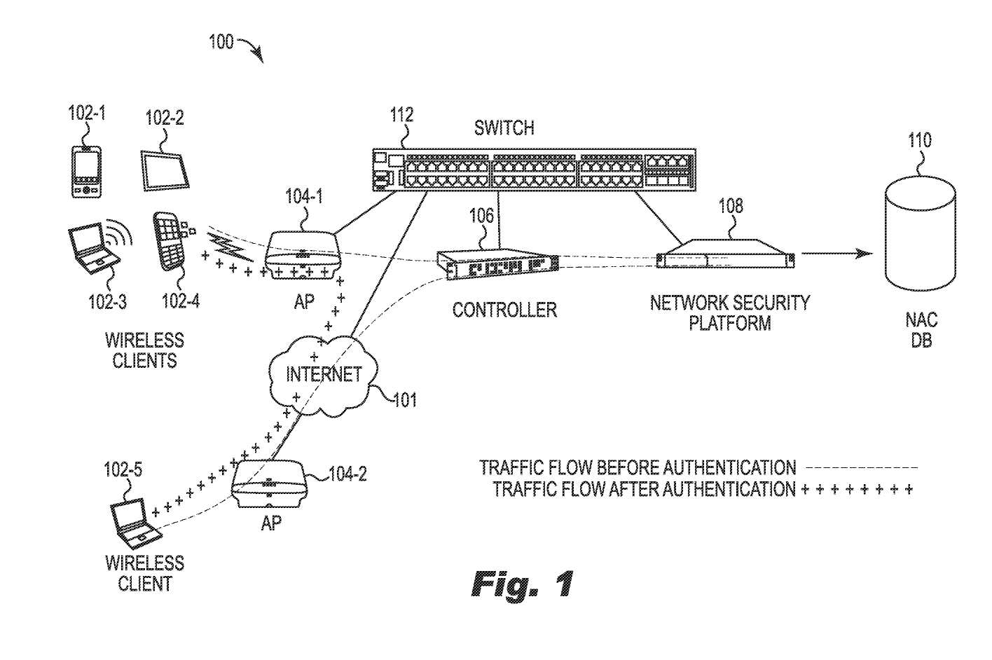

FIG. 1 illustrates an example of a network 100 according to the present disclosure. As shown in FIG. 1, a number of devices can be networked together in a local area network (LAN) and/or wide area network (WAN) via routers, hubs, switches, and the like. As used herein a “network device” means a switch, router, hub, bridge, access point, etc. (e.g., a network infrastructure device connected to a network 100). A wireless LAN may be referred to as a WLAN. Network devices can include a processing resource in communication with a memory resource and may include network chips having hardware logic (e.g., in the form of application specific integrated circuits (ASICs)) associated with the number of network ports. The term “network” as used herein is not limited to the number, type, and/or configuration of devices illustrated in FIG. 1.

The example network of FIG. 1 illustrates a number of wireless clients (generally 102) such as a personal digital assistant 102-1, a tablet 102-2, a first laptop 102-3, a cellular telephone 102-4, and a second laptop 102-5, however examples are not limited to a particular number or type of wireless clients 102. The wireless clients can connect to the network 100 via a wireless air interface (e.g., IEEE 802.11) which can provide a signal link between the wireless clients 102 and an access point (AP) (generally 104) such as first AP 104-1 and second AP 104-2. The AP 104 can serve a similar role to a base station in a cellular network.

The AP 104 can provide more than one VLAN. The AP 104 can have more than one service set identifier (SSID) associated therewith. Each SSID can represent a number of VLANs provided by the single AP 104. Each VLAN provided by the AP 104 can have a distinct set of clients associated therewith.

The AP 104 can provide various security features such as IEEE 802.11i, Wi-Fi protected access 2 (WPA2), and/or WPA to block unauthorized wireless access by authenticating wireless clients 102 prior to granting network access (e.g., in collaboration with the network controller 106 and/or the network security platform 108). Additional security features can include advanced encryption standard (AES) and/or temporal key integrity protocol (TKIP) encryption to secure data integrity of wireless traffic. The AP 104 can perform local wireless bridge client traffic filtering to prevent communication between wireless clients 102 associated with the AP 104.

The AP 104 can be coupled to a switch 112. The switch 112 can be coupled to a network controller 106 and to a network security platform 108. The network controller 106 (e.g., an access point controller) can manage the AP 104, and, in some examples, a plurality of APs. The network controller 106 can provide management and configuration information to the AP 104 over a packet switched or routed signal link (e.g. an Ethernet link). In some examples, a first AP 104-1 can be coupled to the switch 112 and thus to the network controller 106 on a same Layer 3 network and a second AP 104-2 can be coupled to the switch 112 and thus to the network controller 106 across a Layer 3 network boundary (e.g., via a connection to the Internet 101). The controller 106 can be remote from an AP 104-2 (e.g., in different parts of the world). In a number of examples, the network controller 106 can be connected to the network security platform 108 via a same Layer 2 network (e.g., via 802.1Q trunk ports within a same switch 112) or connected via separate Layer 2 switches.

The network controller 106 can provide various security features such as firewall, secure shell, secure socket layer (SSL), authenticated network logons, MAC authentication, web-based authentication, and/or secure management access. The firewall can prevent various levels of network access for wireless clients 102 before authentication via a component internal or external to the network controller 106, such as a remote authentication dial in user service (RADIUS) server and/or an active directory, among others. The secure shell can encrypt data transmitted for secure remote command line interface (CLI) access over Internet protocol (IP) networks. The SSL can encrypt hypertext transfer protocol (HTTP) traffic, allowing secure access to a browser-based management graphical user interface (GUI) in the switch 112. The network controller 106 can authenticate wireless clients 102 for network logons based on MAC addresses of the wireless clients 102, which can be particularly useful for wireless clients with minimal or no user interface (e.g., cellular telephones and/or other smaller portable devices). A web-based authentication can be provided in a web browser based environment to authenticate wireless clients 102 that may not support the IEEE 802.1X supplicant.

The network security platform 108 can be deployed as a standalone hardware appliance or as an application in a virtual server environment. In some examples, when a wireless client 102 first attempts to connect to the network 100, traffic from the client can be routed via the AP 104 through the switch 112 and/or the network controller 106 to the network security platform 108 (e.g., as indicated by the dashed lines in FIG. 1). The network security platform 108 can act as a default gateway and present a web portal for logon of wireless client devices 102 in response to a request from a wireless client 102 prior to authentication of the wireless client 102. An attempt to use the network 100, and attempt to logon via the web portal, and/or other attempts to communicate via the network 100 can be considered a “request” from the wireless client 102. The web portal for logon can present fields for a user to enter a username and password in some examples.

Configuration of wireless devices to use a wireless network may be difficult for non-tech-savvy users. A web portal for logon can be implemented as an easy way for wireless clients 102 to connect to a network 100 without requiring the user to manually configure the wireless device. In some examples, authenticating wireless clients 102 via a web portal may not provide encryption for traffic on the network 100. In some examples, wireless clients 102 can receive an active key after authentication to facilitate encrypted communication over the network 102.

The network security platform 108 can be coupled (locally or remotely) to a machine readable medium, such as database 110 (e.g., a network access control (NAC) database that can store a number of media access control (MAC) addresses of wireless clients 102 associated with the wireless network). The database 110 can be used to authenticate the wireless clients, for example, by comparing a MAC address of the wireless clients 102 and/or a username and password of the wireless clients 102 with entries in the database 110. In some examples, the network security platform 108 can add an authentication state entry in the database 110 after an initial authentication of a wireless client. After the initial association of the wireless client 102, the wireless client 102 can be assigned to an isolation VLAN defined on the network controller 106 that is tunneled through the network security platform 108 and/or the network controller 106.

In response to an initial association of a wireless client 102, the network security platform can send a dissociation command for the wireless client 102 so that the wireless client 102 loses a connection to and/or access to the network 100. In response to a subsequent association followed by an authentication (e.g., a RADIUS authentication) of the wireless client 102, the network security platform 108 can assign traffic to a local VLAN defined on the AP 104 associated with the wireless client 102. In some examples, the local VLAN is not tunneled through the network security platform 108 and/or the network controller 106. For example, traffic for this local VLAN is illustrated in FIG. 1 represented by the “+++” line.

In the following example, interactions between a wireless client 102 and an AP 104 are described, however the actions described with respect to the AP 104 may be directed by the AP 104 itself, by the network controller 106, by the network security platform 108, or a combination thereof. A wireless client 102 can initiate communication with an AP 104 and send an IEEE 802.11 authentication request. The AP 104 can respond to the wireless client 102 with an IEEE 802.11 authentication response. Then, the wireless client 102 can send an IEEE 802.11 association (or re-association) request. The AP 104 can respond with an IEEE 802.11 association response. The wireless client 102 can start an IEEE 802.1X authentication request and an IEEE 802.1X four-way handshake can begin. The wireless client 102 can be successfully connected when the IEEE 802.1X four-way handshake is completed successfully. As described herein, the AP 104 can send a dissociation command to the wireless client 102. The dissociation command can take the form of an IEEE 802.11 de-authentication frame and/or an IEEE 802.11 dis-association frame, however, if a de-authentication frame is used, it may not be necessary to also send a dis-association frame because once the wireless client 102 has been de-authenticated, it cannot stay in an associated state with the AP 104. However, if a dis-association frame is used, the wireless client 102 can stay in an authenticated state with the AP 104. Thus, in some examples, the AP 104 can send a dissociation command comprising only a de-authentication frame. Likewise, in some examples, the AP 104 can send the dissociation command comprising the de-authentication frame after IEEE 802.11 authentication of the wireless client 102 and before IEEE 802.11 association of the wireless client according to the example described above. Such examples can quickly and efficiently disconnect the wireless client 102 from the AP 104. The network security platform 108 can provide network monitoring of network activity, logging of events, collection of historical data, identification and classification of wireless clients 102 and/or corresponding users, alerts for security issues, policy enforcement such as disabling or isolating a network port, automated remediation of security vulnerabilities, and regulatory compliance among other security features. In some examples, the network security platform can provide a number of the security features described above with respect to the network controller 106 to remove such workload from the network controller 106 and allow it to dedicate more resources to other network functionality such as managing access points.

A device in the network 100 can be associated with a port of a switch to which it is connected. Information in the form of packets can be passed through the network 100. Users connect to the network through ports on the network 100. Data frames, or packets, can be transferred between devices by way of a device's (e.g., switch's) logic link control (LLC)/MAC circuitry, or “engines”, as associated with ports on a device. A network switch forwards packets received from a transmitting device to a destination device based on the header information in received packets. A device can also forward packets from a given network to other networks through ports on other devices. An Ethernet network is described herein. However, examples are not limited to use in an Ethernet network, and may be equally well suited to other network types (e.g., asynchronous transfer mode (ATM) networks), etc.

As used herein, a network can provide a communication system that links two or more devices, allows users to access resources on other devices, and exchange messages with other users. A network allows users to share resources on their own systems with other network users and to access information on centrally located systems or systems that are located at remote offices. It may provide connections to the Internet or to the networks of other organizations. Users may interact with network-enabled machine readable instruction (e.g., software and/or firmware) applications to make a network request, such as to get a file or print on a network printer. Applications may also communicate with network management machine readable instructions, which can interact with network hardware to transmit information between devices on the network.

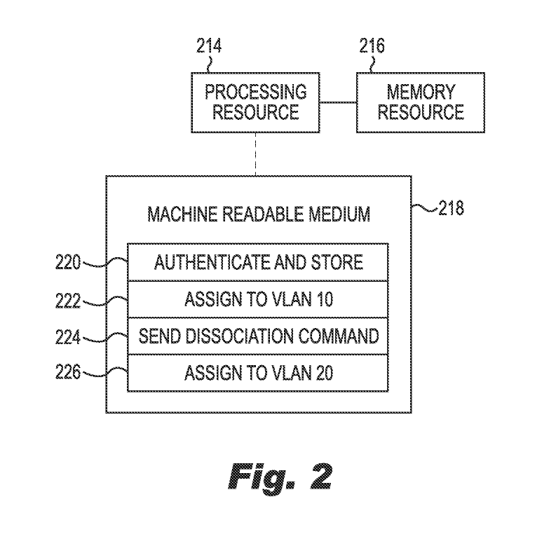

FIG. 2 is a block diagram illustrating a processing resource 214, a memory resource 216, and a machine readable medium 218 according to the present disclosure. The processing resource 214 and the memory resource 216 can be local to a network device such as a network security platform, a network controller, or another network device. The machine readable medium 218 (e.g., a tangible, non-transitory medium) and/or the memory resource 216 can store a set of instructions (e.g., software, firmware, etc.) executable by the processing resource 214. The machine readable medium can be local to the network device or remote therefrom. For those examples in which the machine readable medium is remote from the network device, the instructions can be loaded into the memory resource 216 of the network device.

As used herein, a processing resource 214 can include one or a plurality of processors such as in a parallel processing system. A memory resource 216 can include memory addressable by the processing resource 214 for execution of machine readable instructions. The memory resource 216 can include volatile and/or non-volatile memory such as random access memory (RAM), static random access memory (SRAM), electronically erasable programmable read-only memory (EEPROM), magnetic memory such as a hard disk, floppy disk, and/or tape memory, a solid state drive (SSD), flash memory, phase change memory, etc.

The instructions 220 stored in the machine readable medium 218 can be executed to authenticate a wireless client and store the authentication state in response to an authentication request received from the wireless client. Storing the authentication state can include storing a username and password of the wireless client, a MAC address of the wireless client, and/or other information identifying the wireless client. In some examples, storing the authentication state can include storing a level of authentication for the wireless client such as full access to the network, partial access to the network, access to internal and/or external networks, etc.

The instructions can be executed to maintain a state for the wireless client. The state can indicate what type of device the wireless client is (e.g., laptop, tablet, cellular telephone, etc.).

The instructions 222 can be executed to assign the wireless client to a first VLAN (e.g., “VLAN 10”) that is tunneled via the network device, where the first VLAN is an isolation network, and restricts access only to the network security platform (e.g., network security platform 108 in FIG. 1). A network controller (e.g., network controller 106 illustrated in FIG. 1) can make decisions (e.g., whether to allow access to an internal and/or external network) for network traffic based on VLANs. In some examples where the first VLAN is an isolation VLAN, it may be controlled by the network controller rather than being defined on the AP (e.g., AP 104 illustrated in FIG. 1), however the AP may recognize the VLAN identifier (e.g., “VLAN 10”) and therefore tunnel traffic on that VLAN through the network controller. The traffic may then reach the network security platform.

The instructions 224 can be executed to send a dissociation command to dissociate the wireless client. The dissociation command can be sent (e.g., from the network security platform to the AP via the network controller) in response to the wireless client receiving an initial successful authentication and/or being assigned to the first VLAN. Dissociating the wireless client from a respective AP can cause the wireless client to lose connectivity with the wireless network and thereby force the wireless client to attempt to logon again. When the client attempts to logon again, if the client's authentication state is stored, a network device such as a network security platform can take different actions in response to the subsequent attempt to logon.

For example, the instructions 226 can be executed to assign the wireless client to a second VLAN (e.g., “VLAN 20”) that is not tunneled via the network device based on the stored authentication in response to a subsequent authentication request received for the wireless client. The second VLAN can be a VLAN defined on the AP. In some examples, the second VLAN can provide access to the desired network that offers services useful to the wireless client.

The instructions can be executed to encrypt communications between the wireless client and the network device in response to the subsequent authentication request being a request for both authentication and encryption. Some wireless devices may not be configured for encrypted communication and/or the user may not know how to configure the device for encrypted communication. For example, an employee logging onto a wireless network in the workplace may have a laptop that is authorized to access a local network (e.g., intranet) of the workplace, but the user's personal cellular telephone may not have such authorization or capability. In such an example, the user's laptop may send an authentication and encryption request.

The instructions can be executed to assign the wireless client to a third VLAN that is not tunneled via the network device based on the stored authentication for the wireless client (e.g., business Laptop) and the encrypted communications. In some examples, the third VLAN can provide access to the external network (e.g., the Internet) and to the local network (e.g., an intranet of the business). The third VLAN can be defined on the AP as a local network. In such an example, the employee's cellular telephone may be left on the second VLAN with access to the external network, but not to the internal network so the employee can have Internet access on the cellular telephone, but not access information on the workplace intranet.

In examples that include both authentication and encryption, the authentication can be based on a username and password logon of the wireless client (e.g., via a web portal). The encryption can include the use of an active key associated with the wireless client (e.g., stored in a memory resource of the wireless client) and an advanced encryption standard (AES) cipher, among other encryption methods.

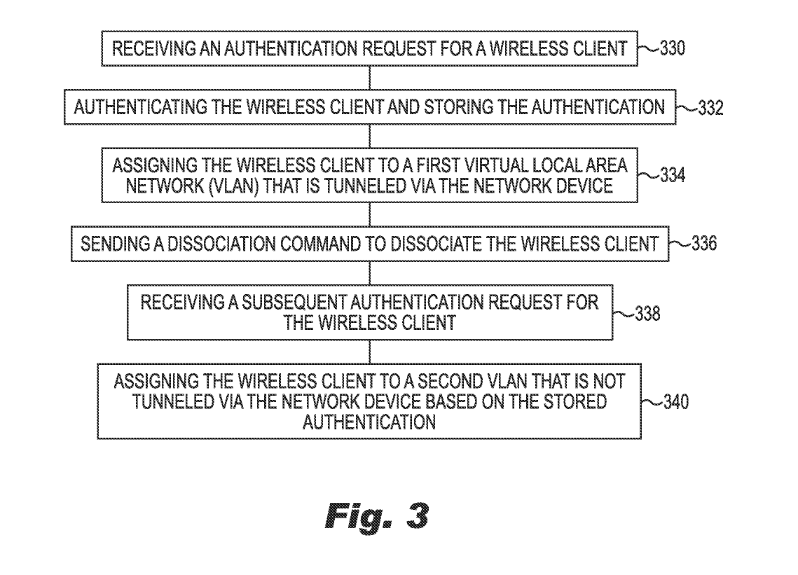

FIG. 3 is a flow chart illustrating an example of a network device (e.g., a network security platform and/or a network controller) implemented method for wireless client authentication and assignment according to the present disclosure. At step 330, the method can include receiving an authentication request from a wireless client. In some examples, the network device can present a web portal for client logon after receiving the authentication request and prior to authenticating the wireless client, as described herein. At step 332, the method can include authenticating the wireless client and storing the authentication. In some examples, the authentication can be stored by storing a MAC address of the wireless client.

At step 334, the method can include assigning the wireless client to a first VLAN that is tunneled via the network device. The network device can act as a dynamic host configuration protocol (DHCP) server and as a domain name system (DNS) server for the first VLAN such that an IP address is assigned to the wireless client via the network device and that the network device provides translation of domain names to IP addresses for the wireless client. In some examples, the network device can also act as a default gateway for the wireless client such that the network device is used to send traffic on behalf of the wireless client.

At step 336, the method can include sending a dissociation command to dissociate the wireless client. The dissociation command can be sent in response to successfully authenticating the wireless client after assigning the wireless client to the first VLAN. In some examples, the network device can be a network security platform (e.g., network security platform 108 illustrated in FIG. 1) and the dissociation command can be sent to a network controller (e.g., network controller 106 illustrated in FIG. 1) that controls an AP (e.g., AP 104 illustrated in FIG. 1) via which the wireless client (e.g., wireless clients 102 illustrated in FIG. 1) communicates with the network (e.g., network 100 illustrated in FIG. 1).

At step 338, the method can include receiving a subsequent authentication request for the wireless client. At step 340, the method can include assigning the wireless client to a second VLAN that is not tunneled via the network device based on the stored authentication. The second VLAN can be bridged locally at the AP and not tunneled to the network controller or to the network security platform.

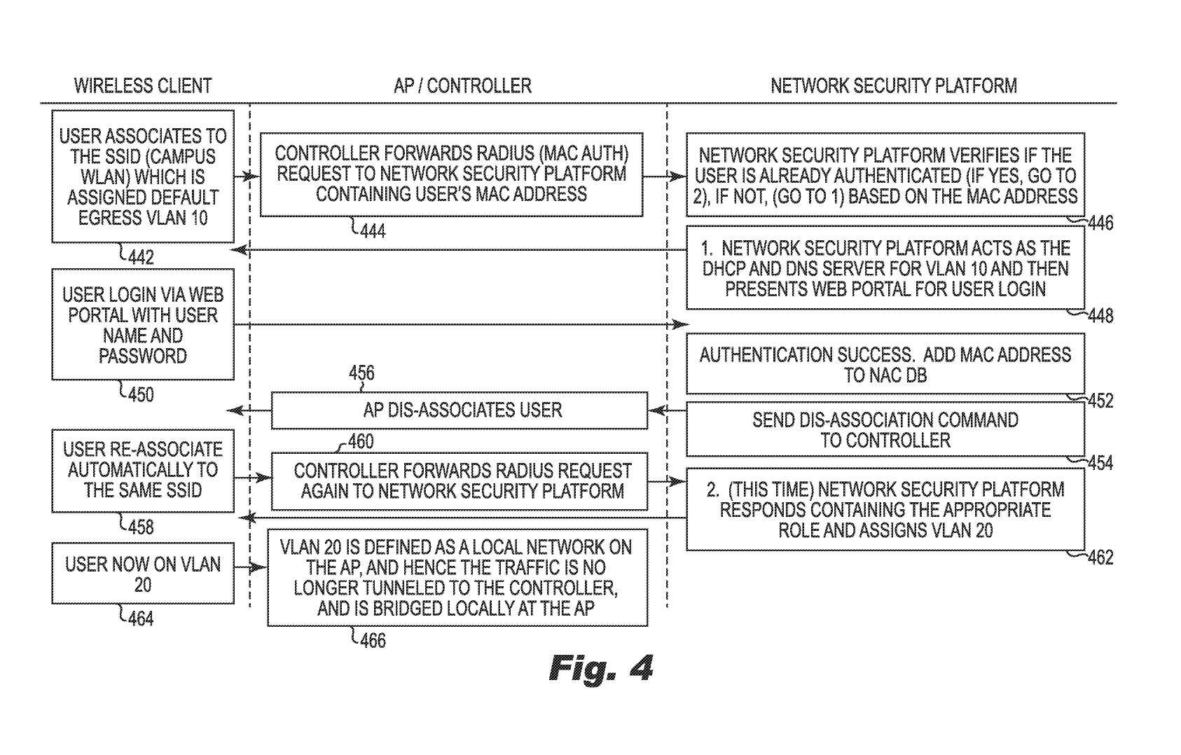

FIG. 4 is a flow chart illustrating an example of a method for wireless client authentication and assignment according to the present disclosure. The flow chart illustrates functionality that can be provided by a number of network devices such as an access point (“AP”) and/or network controller (in the middle) and/or a network security platform (on the right), as well as functionality provided to a wireless client (on the left).

At step 442 a wireless client can associate with an AP (e.g., “user associates to the SSID (Campus WLAN) which is assigned default egress VLAN 10”). The initial association between the wireless client and the AP may be considered an authentication request, which may be forwarded via a network controller to a network security platform as illustrated at step 444 (e.g., “controller forwards RADIUS (MAC auth) request to network security platform containing user's MAC address”). At step 446, the network security platform can determine whether the wireless client is authenticated and take action based on that determination (e.g., “network security platform verifies if the user is already authenticated (if yes, go to 2), if not (go to 1) based on the MAC address”).

At step 448 (e.g., “1”), the network security platform can control traffic for the default VLAN and present a web portal for user logon (e.g., network security platform acts as the DHCP and DNS server for VLAN 10 and then presents web portal for user logon”). The wireless client can use the web portal for authentication at step 450 (e.g., “user login via web portal with user name and password”). The network security platform can authenticate the wireless client and, in some examples, store the authentication at step 452 (e.g., “Authentication success. Add MAC address to [network access control database, also known as] NAC DB”). In response to authenticating the wireless client, the network security platform can send a command (e.g., to the AP via the network controller) to dissociate the wireless client at step 454 (e.g., “send dis-association command to controller”). At step 456 the AP can dissociate the wireless client (e.g., “AP dis-associates user”). In some examples, the wireless client, which is still in range of the AP will automatically attempt to reestablish an association with the AP at step 458 (e.g., “user re-associate automatically to the same SSID”), however, examples are not limited to automatic attempts to re-associate with the AP, as such may be done partially or completely manually. The wireless client's re-association generates a request for authentication and can be forwarded to the network security platform at step 460 (e.g., “controller forwards RADIUS request again to network security controller”).

At step 462 (e.g., “2”), whether in response to a subsequent request for authentication (e.g., after step 460) or in response to a user already being authenticated (e.g., after step 446), the network security platform can assign the wireless client to a local VLAN defined on the AP (e.g., “(this time) network security platform responds containing the appropriate role and assigns VLAN 20”), which puts the user on the local VLAN at step 464 (e.g., “user now on VLAN 20”). As described herein, the local VLAN can be bridged locally on the AP such that traffic is no longer tunneled through the network controller and/or the network security platform at step 466 (e.g., “VLAN 20 is defined as a local network on the AP, and hence the traffic is no longer tunneled to the controller, and is bridged locally at the AP.”).

The methods, techniques, systems, and apparatuses described herein may be implemented in digital electronic circuitry or computer hardware, for example, by executing instructions stored in machine readable storage media. Apparatuses implementing these techniques may include appropriate input and output devices, a computer processor, and/or a tangible machine readable storage medium storing instructions for execution by a processor.

A process implementing techniques disclosed herein may be performed by a processor executing instructions stored on a tangible machine readable storage medium for performing desired functions by operating on input data and generating appropriate output. Suitable processors include, by way of example, both general and special purpose microprocessors. Suitable machine readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

What is claimed is:

1. A network device, comprising:
a processing resource;
a memory resource coupled to the processing resource, wherein the memory resource stores instructions executable by the processing resource to:
act as a default gateway and present a web portal for logon in response to a request from a wireless client prior to authentication of the wireless client;
send a dissociation command for the wireless client in response to an initial authentication of the wireless client; and
assign traffic to a local virtual local area network (VLAN) defined on an access point (AP) associated with the wireless client in response to a subsequent authentication of the wireless client.

2. The device of claim 1, wherein the instructions are executable by the processing resource to authenticate the wireless client by at least one of:
a username and password received via the web portal, comprising the initial authentication; and
a media access control (MAC) address of the wireless client.

3. The device of claim 2, wherein the instructions are executable by the processing resource to store the MAC address of the wireless client after the initial authentication.

4. The device of claim 1, wherein the instructions are executable by the processing resource to assign traffic from the wireless client to an isolation VLAN that is tunneled through the network device in response to the initial authentication; and
wherein the local VLAN is not tunneled through the network device.

5. A network device implemented method, comprising:
receiving an authentication request for a wireless client;
authenticating the wireless client and storing an authentication state;
assigning the wireless client to a first virtual local area network (VLAN) that is tunneled via the network device;
sending a dissociation command to dissociate the wireless client;
receiving a subsequent authentication request for the wireless client; and
assigning the wireless client to a second VLAN that is not tunneled via the network device based on the stored authentication state.

6. The method of claim 5, wherein the method includes the network device acting as a dynamic host configuration protocol (DHCP) server and as a domain name system (DNS) server for the first VLAN.

7. The method of claim 5, wherein the method includes the network device presenting a web portal for client logon after receiving the authentication request and prior to authenticating the wireless client.

8. The method of claim 5, wherein storing the authentication state comprises storing a media access control (MAC) address of the wireless client.

9. The method of claim 5, wherein the method includes sending the dissociation command in response to successfully authenticating the wireless client after assigning the wireless client to the first VLAN.

10. The method of claim 5, wherein the network device comprises a network security platform; and
wherein sending the dissociation command comprises sending the dissociation command to a network controller that controls a wireless access point (AP) via which the wireless client communicates with the network.

11. The method of claim 10, wherein the second VLAN is bridged locally at the AP and not tunneled to the network controller or to the network security platform.

12. A tangible, machine readable medium storing a set of instructions for network authentication with local traffic distribution, which when executed by a processor cause a network device to:
authenticate a wireless client and store an authentication state in response to an authentication request received for a wireless client;
assign the wireless client to a first virtual local area network (VLAN) that is tunneled via the network device, wherein the first VLAN is an isolation VLAN and limits the wireless client to accessing only the network security platform;
send a dissociation command to dissociate the wireless client; and
assign the wireless client to a second VLAN that is not tunneled via the network device based on the stored authentication state in response to a subsequent authentication request received for the wireless client, wherein the second VLAN provides access to a desired network offering services useful to the wireless client.

13. The medium of claim 12, wherein the instructions cause the network device to maintain a state for the wireless client, wherein the state indicates a type of device comprising the wireless client.

14. The medium of claim 12, wherein the instructions cause the network device to:
encrypt communications between the wireless client and the network device in response to the subsequent authentication request comprising an authentication and encryption request; and
assign the wireless client to a third VLAN that is not tunneled via the network device based on the stored authentication state and the encrypted communications, wherein the third VLAN provides access to the external network and to the local network.

15. The method of claim 14, wherein authenticating the wireless client according to the authentication request includes authenticating the wireless client via a username and a password; and
wherein encrypting communications according to the subsequent authentication and encryption request includes using an active key and an advanced encryption standard (AES) cipher.
